(19) United States
(12) Patent Application Publication
(10) Pub. No.: US 2008/0037987 A1
(43) Pub. Date: Feb. 14, 2008

(54) Communication/power network having out-of-band time and control signaling

(76) Inventors: Albert M. Bradley, North Falmouth, MA (US); Frederick Sonnichsen, East Falmouth, MA (US); Steven Lerner, Falmouth, MA (US); Andrew R. Maffei, East Falmouth, MA (US); Alan D. Chave, Falmouth, MA (US)

Correspondence Address: ROPES & GRAY LLP;PATENT DOCKETING 39/41, ONE INTERNATIONAL PLACE, BOSTON, MA, 02110-2624, US

(21) Appl. No.: 11/702,851

(22) Filed: Feb. 6, 2007

Related U.S. Application Data
(60) Provisional application No. 60/771,048, filed on Feb. 6, 2006.

(51) Int. Cl. H04J 14/00

(52) U.S. Cl. 398/59; 398/58

(57) ABSTRACT

The systems and methods provide an out-of-band time and control signal distribution network that may be employed in conjunction with a large scale area network. The network is capable of installation on the seafloor and comprises a plurality of network nodes being interconnected by fiber optic cable, and each having optical transceivers for coupling to an optical fiber cable having data channels carrying data packets among the plurality of network nodes and having one or more control and time channels for carrying control and time signals, and an out-of-band communications module for coupling to the optical fiber cable to utilize the control and time data signals transmitted separately from the data packets, to provide the distribution of in-band data packets among network nodes and the distribution of out-of-band timing and control signals to said plural network nodes.

### CROSS-REFERENCE TO RELATED APPLICATIONS

This application claims priority to and the benefit of U.S. Provisional Patent Application Ser. No. 60/771,048, filed on Feb. 6, 2006 and entitled “Communication/Power Network Having Out-Of-Band Time And Control Signaling,” the entire contents of which are incorporated herein by reference.

### GOVERNMENT CONTRACT

The U.S. Government has a paid-up license in this invention and the right in limited circumstances to require the patent owner to license others on reasonable terms as provided for by the terms of Contract No. OCE 079720 awarded by the National Science Foundation.

### BACKGROUND OF THE INVENTION

Today, computer and power network systems are being placed in geographically and environmentally remote locations. For example, there is a growing interest in ocean observatories such as the NEPTUNE regional cabled observatory. These observatories are really large computer and power networks comprising a fiber optic cable that interlinks a number of observatory nodes, each of which is capable of serving scientific equipment such as spectrometers or seismometers. These seafloor observatories may be located many hundreds of kilometers off the coast of the nearest shore station and may be positioned at depths of over 5000 meters. Typically, the observatory has one or more network connections to shore stations through which data collected from the seafloor observatory can be passed onto the Internet and which can serve seafloor instruments with power and control commands.

Servicing and maintaining the undersea network is a complicated and potentially costly task because complex electronic systems must be placed on the seafloor to aggregate, route, and transfer data along optical fibers, and to provide variable amounts of power to both the infrastructure and scientific instruments. These data and power systems require a high reliability method to provide control and monitoring functions that is independent of the main data network. In addition, there is a scientific requirement to provide synoptic high accuracy time to instruments which cannot be accommodated using standard IP protocols like Network Time Protocol on the main data network. These requirements apply in any data/power network which is remote and difficult to access physically.

### SUMMARY OF THE INVENTION

The systems and methods described herein provide for more robust data/power networks and in particular more robust data/power networks of the type that can be deployed at remote and difficult to access locations. In particular, the systems and methods described herein provide an out-of-band time and control signal distribution network that may be employed in conjunction with and separately from a large scale data/power network.

In one aspect, the systems and methods described herein include a communication network capable of installation on the seafloor. The communication network comprises a plurality of network nodes being interconnected by fiber optic cable. One or more of the plurality of network nodes may include optical transceivers for coupling to an optical fiber cable having data channels carrying data packets among the plurality of network nodes and having one or more control and time channels for carrying control and time signals. The nodes also include an out-of-band communications module for coupling to the optical fiber cable to utilize the control and time data signals transmitted separately from the data packets, to provide the distribution of in-band data packets among network nodes and the distribution of out-of-band timing and control signals to said plural network nodes. In certain embodiments, the network nodes are arranged in an architecture selected from the group consisting of a mesh architecture, a bus architecture, a ring architecture, or a star architecture.

In certain embodiments, the out-of-band communications module further comprises a control module for regulating the flow of control and time signals across the optical channel. The control module may include a time distribution module for distributing a NIST-traceable time signal corrected for transmission latency among the plural network nodes. In such embodiments, the communication network may also include a means for measuring the transmission latency among the plural network nodes. In certain embodiments, the control module further includes an interface controller for selectively allowing a plurality of data channels internal to the network node to access the optical channel carrying control and time signals among the network nodes. In such embodiments, the control module allows one node at a time to access the control and time signals among all of the network nodes. The module may further include a media access controller for blocking data from being received over a channel in response to detecting data being received on another channel. Additionally and optionally, the communication network may comprise a control circuit for regulating access to a given optical path carrying control and time signals among the network nodes and capable of suppressing multiple repeats of said signal.

In certain embodiments, the communication network comprises a serial interface circuit for communicating optical data over the optical channel at a rate of between 50 BAUD (Bits Per Second) and 115,000 BAUD. In such embodiments, the communication network further comprises a base band keying circuit for on/off keying a laser diode to generate data signals for distribution over the optical channel. The laser diode may include a communications laser.

The network may comprise a power regulator circuit for regulating the power applied to the laser diode. The power regulator circuit may utilize the internal Laser Diode monitor diode to monitor optical power generated by the laser diode using a non-carrier based communications protocol and a feedback loop to regulate the power generated thereby. In certain embodiments, the network comprises a wake-up circuit for causing the device to enter into an active state in response to an incoming signal. The network may also comprise a time distribution system for synchronizing clocks within the network nodes in response to a timing pulse transmitted over the optical channel. In certain embodiments, the communication network comprises a low power sleep mode allowing a control module to turn itself off by timed prearrangement or by lack of incoming signals. The network may have in situ battery power for at least one week.

In another aspect, the systems and methods described herein include a communication network comprising a master node and a plurality of network nodes arranged into a selected network configuration. The master node may include a data packer generator, control and time distribution circuits for generating control and time signals and a NIST-traceable time source. In certain embodiments, the system includes a steering module to allow operation in mesh, bus, ring, or star architectures and an optical transceiver for transmitting and receiving data as optical signals over an optic channel. The plurality of networks may include an optical transceiver for coupling to an optical channel carrying data packets among the plurality of network nodes and having a control and time channel for carrying control and time signals.

The plurality of network nodes may also include an out-of-band communications module for coupling to the optical fiber cable to detect the control and time signals transmitted separately from the data packets, to thereby provide the distribution of in-band data packets among network nodes and the distribution of out-of-band time and control signals to said plural network nodes.

### BRIEF DESCRIPTION OF THE FIGURES

The foregoing and other objects and advantages of the invention will be appreciated more fully from the following further description thereof, with reference to the accompanying drawings wherein;

FIG. 1 depicts a functional block diagram of a network having an out-of-band time and control system according to the invention.

FIG. 2 provides a more detailed depiction of the time distribution system illustrated in FIG. 1.

FIG. 3 provides a block diagram of one node of the system depicted in FIG. 1.

FIGS. 4A and 4B depict in more detail the opto-electronics and steering board mechanism depicted in FIG. 3.

FIG. 5 is a functional block diagram of one embodiment of a steering board.

FIGS. 6A and 6B depict pictorially a process of selecting steering module paths.

FIGS. 7A and 7B depict pictorially a system that prevents ring around from occurring in the data network.

FIG. 8 depicts a system for correcting transmission latency among the nodes of a network.

FIG. 9 depicts a power regulator circuit for the laser diode.

### DETAILED DESCRIPTION OF THE INVENTION

The systems and methods described herein include improved systems and methods for operating, monitoring, and diagnosing data/power networks, including network equipment and network devices that are located in remote and difficult to access locations. In particular, the systems and methods described herein provide out-of-band control and time signal distribution systems that allow for access to principle in-band data communication modules and power modules in distributed network nodes, independent of the proper functioning of those principle modules. Additionally, the systems and methods described herein allow for accessing the modules in the network node via their primitive, typically low data rate, access methods and protocols and employ a minimal suite of simple equipment for the out-of-band system. Additionally and optionally, the systems provide for low power consumption permitting operation on auxiliary power such as a battery during malfunction of the power system.

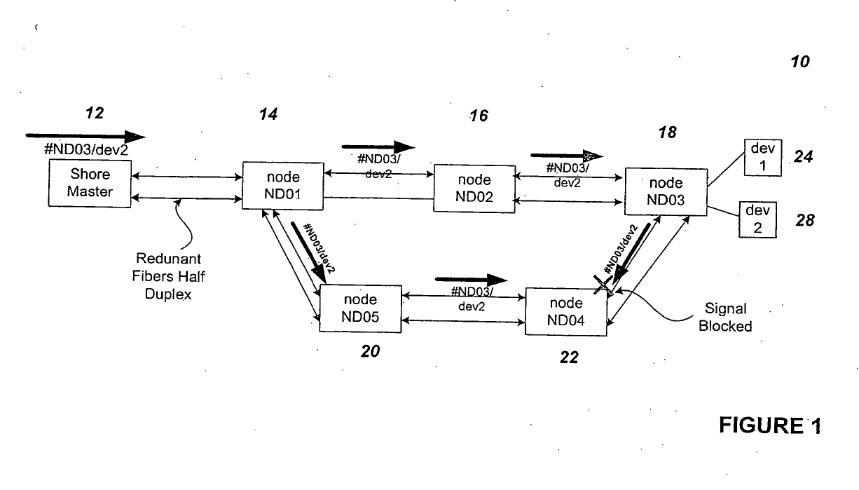

FIG. 1 depicts one embodiment of a system according to the invention wherein an out-of-band control and time distribution system is provided. In particular, FIG. 1 depicts a network 10 that comprises a shore master node 12, and a plurality of slave nodes 14-22. As further shown in FIG. 1, the slave nodes may have scientific equipment and devices such as the depicted devices 24 and 28 that couple to node 18. The depicted shore node 12 and the slave nodes 14-22 are interconnected through communication paths that in this embodiment are optical fiber full duplex data communication paths. In the embodiment shown, one fiber pair east and one fiber pair west carry the out-of-band data and time sync concurrently on each fiber. Each fiber may operate independently in half duplex mode, thus the system 10 may be quadruply redundant. An additional “north” fiber pair may be added in case of three-way branching nodes.

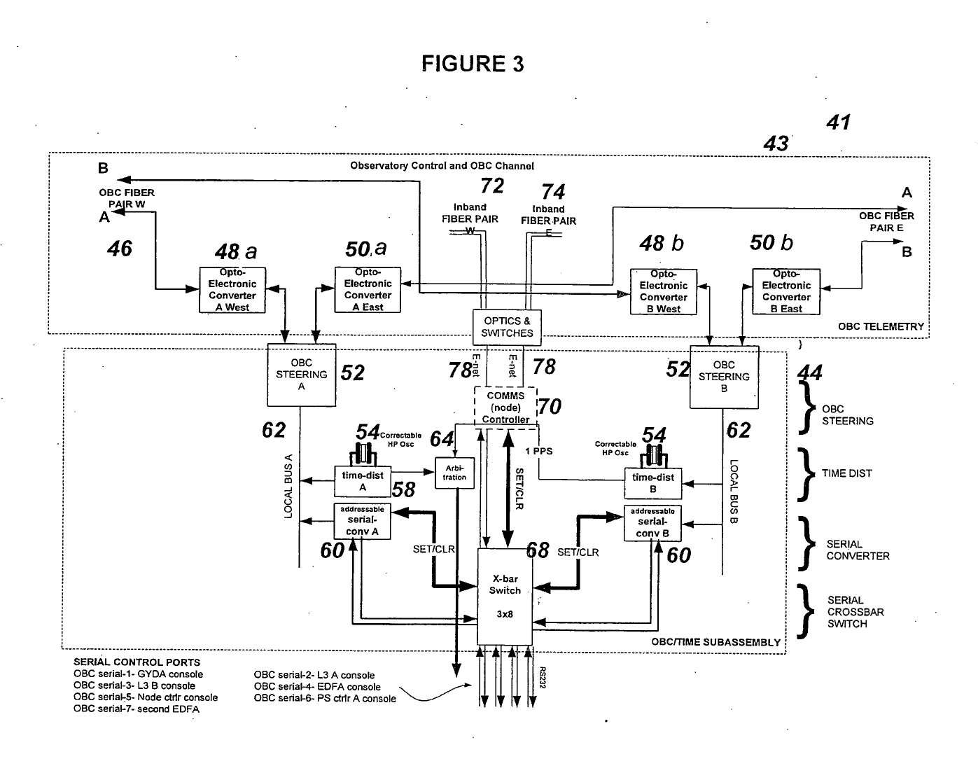

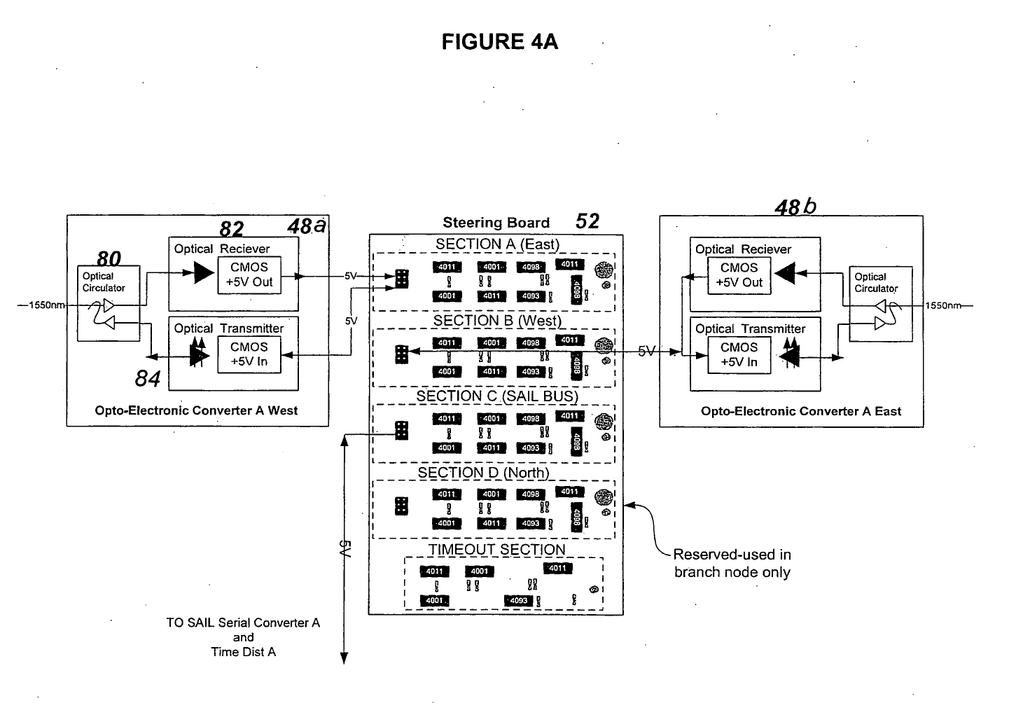

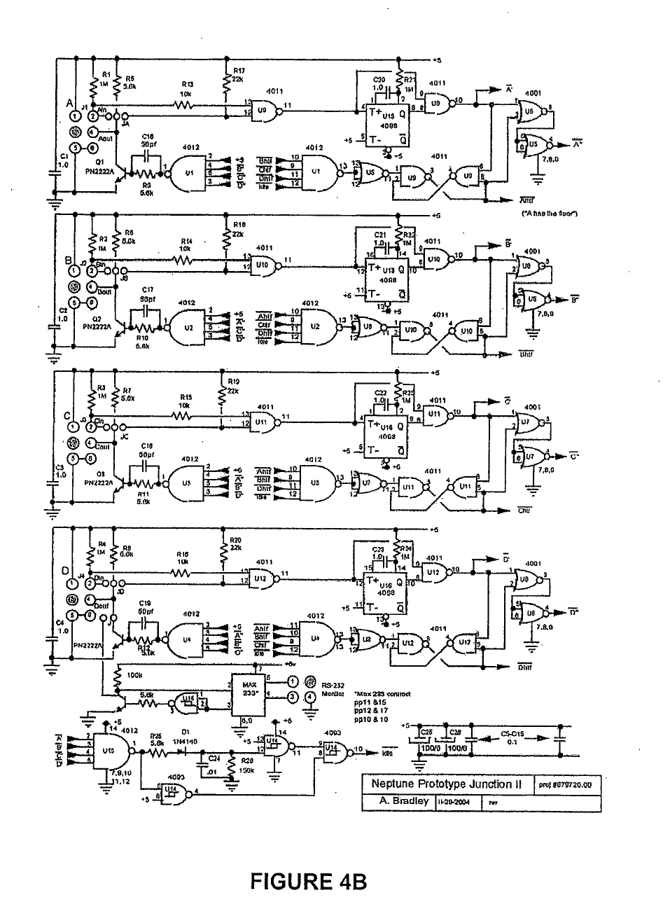

The system 10 may be a master/slave communication system. In such an embodiment, the master node may be the shore node 12 that is placed on shore and that solicits data streams from the slave nodes 14-22 or from slave devices that are connected to the nodes 14-22. In such an embodiment, the nodes cannot initiate communications but will respond to commands or requests for communication and data from the master node 12. The master node may have a terminal to provide an operator with an input device into which they can type a node address prior to entering lines of data. The master node 12 can transmit the data to the adjacent nodes and they in turn will relay the data to the next adjacent nodes. This process continues until the data has reached all of the nodes. Each node has a unique address. Only the node with the respective address will respond. When it does, after solicitation by the master, the process above is reversed and the response is relayed back to the master node. A steering module on each node prevents it from transmitting when it is in the process of relaying data. If the data arrive at a node in the process (state) of relaying data from another node or another fiber, it ignores the received data for a period of time known as the “quiescence time”. When a node receives one or more frames of data containing the address of the node (node address), the frame is further broken down. A sub-address identifies the device within the node, such as a router, for which the data are destined. A cross-bar switch (shown in FIG. 3) interprets the address and connects the received data stream from the SAIL module (shown in FIG. 4A) to the designated equipment. A shore station will also send out periodic, such as 15 minute, timing sync updates which are processed by the nodes in the network 10.

In particular, FIG. 1 depicts pictorially the transmission of a data signal from a shore master node 12 to device 2 (28) attached to node 03 (18). As shown, the transmitted signal addressed to #ND03/DV2 is transmitted from the shore master node 12 to the node 14, forwarded to node 16 and forwarded to node 18, which compares the address in the packet to the address used by node 18. FIG. 1 further shows that node 14 sends the data packet to both node 16 and node 20. Node 20 forwards the message on to node 22, and node 22 terminates transmission of that signal when it receives the similar signal from node 18.

The network 10 depicted in FIG. 1 is a type of network that may be deployed at a remote location, and for the purpose of illustration the network 10 will be described hereinafter as a network employed as part of a seafloor observatory network of the type used for scientific exploration. Such networks may be deployed in oceans or lakes at depths of 100 to 5000 or more meters below the surface. The distance between nodes may range from hundreds of meters to hundreds of kilometers. In the embodiment depicted in FIG. 1, the node 10 includes a shore node 12 that acts as the master node for the network 10. In optional embodiments, the shore node 12 may be absent and the network 10 may work from an alternate master node or may have a master node that is disposed on the ocean floor but providing for coupling or data transmission to a shipboard terminal or network node. In any case, it will be apparent to those of skill in the art that FIG. 1 merely depicts an illustrative embodiment of a network of the type that may use an out-of-band time and control signal distribution system, and that this depicted network is merely one example and that other examples of networks having other architectures, topologies and equipment may be realized without departing from the scope hereof.

For an undersea network, each of the nodes, or at least a portion of the nodes, in the network 10 may be undersea nodes having watertight housings of the type capable of withstanding substantial hydrostatic pressure. In one embodiment, the watertight housings may be formed from suitable waterproof or water impermeable material. In particular, the water proof material may be formed from fine polyester/nylon blends, rubber or plastic, hydrophobic material or other non-porous materials and may include suitable sealants. The watertight housings may include at least one layer of NEOPRENE® or GORETEX®. In other embodiments, the watertight housings may formed by coating a layer of waterproof material on a non-waterproof material. The watertight housings may also have one or more layers of material that may be impermeable to other liquids and gases. The watertight housings may also have of one or more layers of material that may be resistant to high temperature and pressure (e.g., high-temperature and high pressure at ocean depths of greater than 300 m). In other embodiments, the watertight housings may comprise of one or more layers of material that may be resistant to corrosive and abrasive substances. In still other embodiments, the watertight housings may comprise of one or more layers of material that may be resistant to abuse from wildlife. In certain embodiments, a portion of the watertight housings may be formed from a material that allows the signal to be transmitted, to pass through. As an example, for optical communication, a portion of the watertight housing may be formed from a transparent material to allow light rays to pass through. The watertight housing substantially prevents environmental damage to the node and its various internal components including the sensitive electronic circuits therein. Similarly, watertight cabling may be used to interconnect the nodes. The watertight cabling may be of the type used with undersea telecommunication networks. The housings and cabling may be disposed on the seafloor. In the depicted embodiment, the cabling includes fiber optic elements as well as copper wire.

In this out-of-band control and time distribution system 10 one fiber optic pair referred to as fiber pair east and one fiber optic pair referred to as fiber pair west carry the out-of-band data and the time sync signals concurrently on each fiber. Each fiber may operate independently in half duplex mode, thus providing a system that is quadruply redundant. In optional embodiments where a sub-sea node is to provide an additional branch, a north fiber pair may be added as needed. Node 14 is an example of a node have east, west and north fibers and has a branch that extends between node 14 and node 16 and a branch that extends between node 14 and node 20. In other embodiments additional branches may be employed. The number of branches, and fiber pairs that connect to a node will depend upon the application and architecture employed.

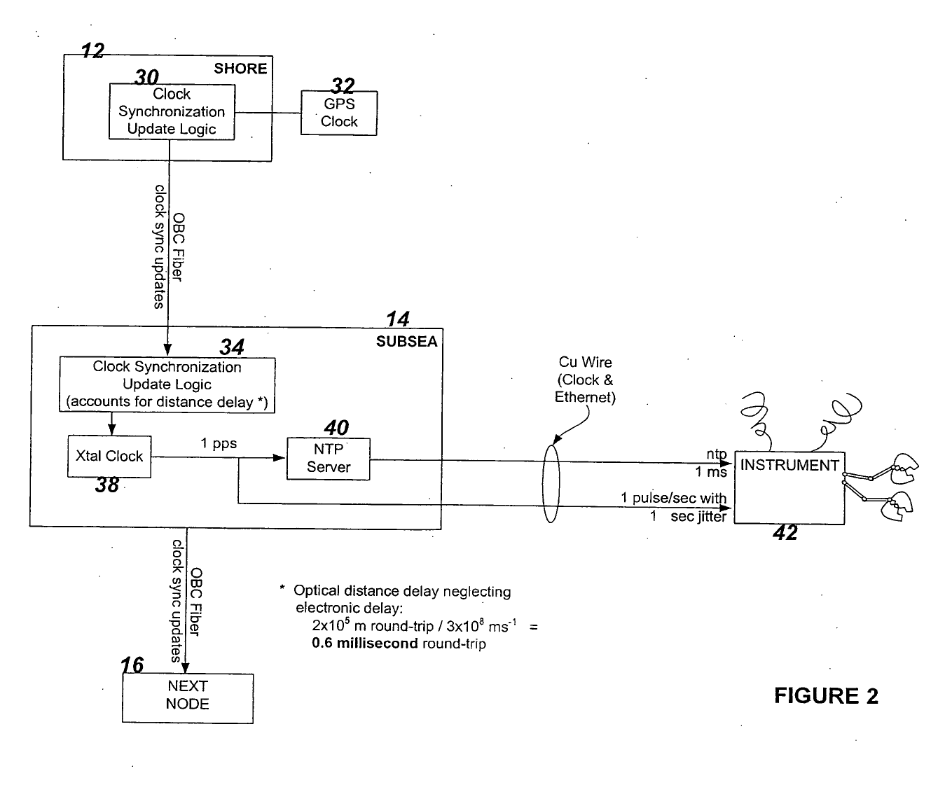

The optical fibers can carry the clock signal between the nodes. As shown in FIG. 2, the shore node 12 can have a synchronization board 30 that will couple to a GPS clock 32. The GPS clock 32 can act as a master clock that generates an accurate signal which the clock synchronization board 30 can use to generate the clock sync update signal. The next clock signal as shown in FIG. 2 is delivered across the OBC fiber to a clock sync update board 34 in the sub-sea node 14. The clock sync update logic board 34 is capable of adjusting the clock sync signal to take into consideration the latency that arises from the transfer of the sync signal across the multiple meters that make up the OBC fiber run. For example, a typical optical distance delay, neglecting electronic delay, is about 2×10⁵ meters round trip at 2×10⁸ m/sec [2×10⁵÷2×10⁸] which equals about 1 millisecond per round trip. The clock sync logic board 34 can adjust the clock sync signal to take into consideration the distance delay and can pass the adjusted signal to the crystal clock 38. The crystal clock 38 can be a normal conventional crystal clock of the type that is commonly used in a network node or a server station for generating a clock signal. The crystal clock 38 may be adjustable so that the latency adjusted sync pulse generated by the clock sync board 34 can adjust the crystal clock so that the one pulse per second generated by crystal clock 38 is synchronized and adjusted for latency to the clock signal being used by shore node 12.

As shown in FIG. 2 the one pulse per second clock signal may, optionally, be passed to a network time protocol (NTP) server 40. The NTP server 40 may deliver the clock signal appropriate for the instrument 42. As also shown in FIG. 2 the crystal clock 38 may have a connection to the instrument 42 as well. In this way the instrument 42 receives the one pulse per second signal for the purpose of correcting any on board clock skew or any clock inaccuracies that arise within the instrument 42.

In one embodiment, to meet the stringent jitter requirement, a low speed optical system is provided which employs direct on/off modulation of a communications laser. This is shown in FIG. 9. Use of commercially available optical transceivers which employ a continuous wave carrier may cause jitter. Further, commercial equipment commonly maintains a carrier wave during an idle mode which consumes auxiliary power and is therefore undesirable. In one embodiment, the system employs a laser transmitter that uses direct on/off modulation to generate the timing signal.

Turning to FIG. 3 one embodiment of the out-of-band control (OBC) module is shown as a functional block diagram in FIG. 3. In particular, FIG. 3 shows an OBC module 41 that includes an OBC telemetry module 43 and OBC/time-and-control sub-assembly 44. The OBC telemetry module 43 includes four opto-electronic converter boards 48a and 48b and 50a and 50b. The OBC time-and-control sub-assembly 44 includes two OBC steering boards 52, a time distribution board 58 that couples to a oscillator 54 and to an arbitration module 64, and also includes a SAIL serial converter board 60 and a cross bar switch 68, as well as a communication node controller 70.

Turning to the OBC, telemetry module 43 couples the node to the fiber cables that carry both the in-band and out-of-band signals. The in-band fiber pairs of which there are at least two, one west and one east, come inward on fiber pairs 72 and 74 and they couple to the optics and the switches device 76. The optics and switches device 76 couples to Ethernet connections 78 that connect to communication node controller 70. In this way in-band data and control signals can be sent through the optical fibers and can couple into the node through the optical switches 76 and the communication node controller 70. Through the in-band data interface, high-speed data transmission can occur across the network system and during typical operations the majority of data collected by the instruments can be transferred among the nodes and to the shore node 12. The telemetry module 43 also services the out-of-band control and time signals and interfaces the node to the fibers carrying that out-of-band time and control data. As shown in FIG. 3, the telemetry module 43 couples to the OBC fiber pairs 46, both the east and the west that carry the OBC signals across the network. The OBC fiber pair west couples to two converter boards, converter board 48a and converter board 48b. Each of the converter boards 48a and 48b couple to an OBC steering board 52 that interfaces the telemetry module 43 with the OBC time-and-control sub-assembly 44. The OBC fiber pair east couples to the opto-electronic converter 50a and the opto-electronic converter 50b. Again these opto-electronic converter boards interface to respective ones of the OBC steering boards 52 in the OBC time-and-control sub-assembly 44.

Consequently, each OBC steering board 52 couples to an opto-electronic converter that interfaces with one fiber in a west pair and one fiber in an east pair. The redundant OBC steering modules 52 as well as the other components provide redundant paths for the OBC time and control data to enter into the node or to be delivered from the node. This provides fault redundancy that increases the reliability of the node. For purposes of clarity the remaining description of the OBC time-and-control sub-assembly 44 will be done with reference to the OBC steering board 52 that couples to the Bus A 62 on the left side of the cross bar switch 68. In particular, the OBC steering module 52 couples to a Bus A 62 that allows for bi-directional signal distribution between the time distribution card 58 and the SAIL serial converter board 60.

The OBC steering module 52 is depicted in more detail in FIGS. 4A and 4B as are the opto-electronic converters for the west and east going fibers. The opto-electronic converter boards 48a include an optical circulator or splitter/coupler 80 that couples to the optical fiber carrying a 1550 nm optical signal. The circulator 80 couples to the optical receiver 82 and to the optical transmitter 84 thereby providing bi-directional data communication signals through the circulator 80. As further shown in FIG. 4A, the receiver outputs a TTL level signal to Section A (east) of the steering module 52. The steering module 52 regulates data flow in and out of the respective node, regulating data flow such that only one section transmits data at a time. Data enters from a line into that line's section, such as Section A, Section B, Section C and so on, and is then relayed out of the steering module 52 via the remaining sections. During this process, the receive is blocked on the remaining sections to prevent them from attempting to relay data. When the Section A is transmitting it sends out data through Ports B, C and D. Ports B, C, and D cannot receive and relay other transmissions during this time. A time-out circuit prevents monopolization by Section A. The opto-electronic converters 48a and 48b transform a half-duplex optical signal on a single fiber into a square wave at CMOS levels. The CMOS level signal is transmitted from the receivers to the appropriate section in the steering board 52 and similarly when the respective sections of the steering board 52 are to transmit data, the sections transmit CMOS level signals to the optical transmitters 84 in the opto-electronic converter boards 48a and 48b.

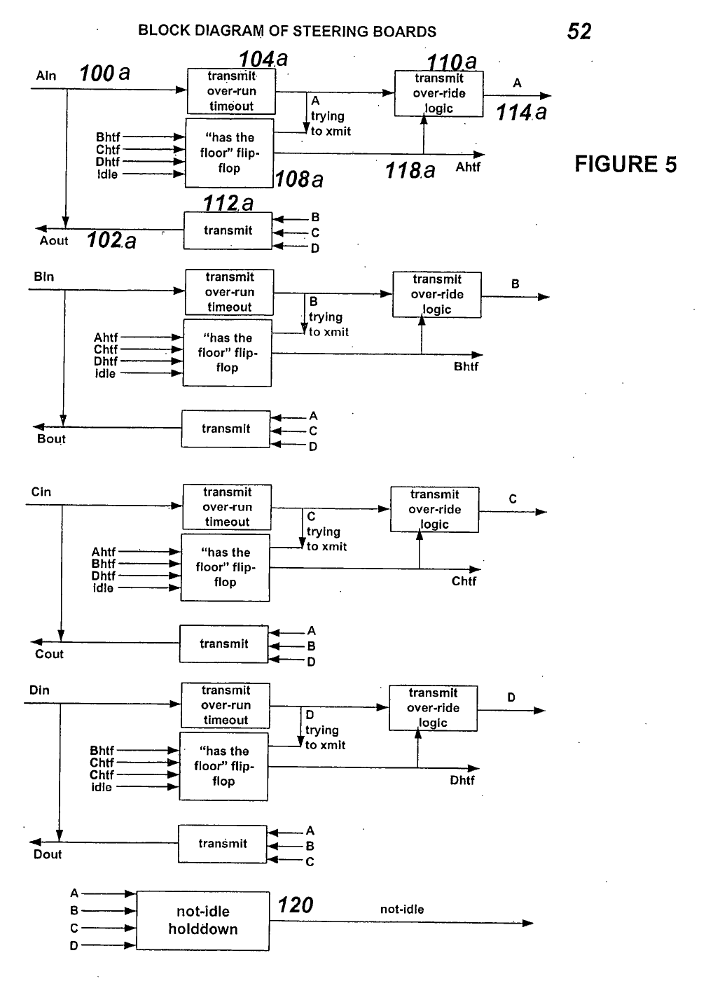

FIG. 5 depicts a functional block diagram of the steering boards and in particular illustrates that each Section A, B, C and D employs a similar control circuit. For the purpose of clarity the following description will discuss the circuit of Section A, but it will be apparent that the circuits associated with Sections B, C and D are constructed and operate similarly.

Specifically, FIG. 5 illustrates that data come in on line 100a to the transmit over run time out block 104a. This may be a monostable vibrator circuit that, after a set period of time, blocks any further transmission of A. The signal from the transit over-run time out block 104a is transmitted to the transmit over-ride logic 110a which generates the signal A 114a. Also shown in the Figure are the “has the floor” control signals for sections B, C and D, which feed into the flip-flop 108a. Flip flop 108a also receives the “A trying to transmit” signal from circuit 104a. The flip-flop 108a generates, according to the flip flop state, an A has the floor (A, H & F) signal 118a that connects to the flip-flops of sections B, C and D. A transmitter 112a receives output signals from Sections B, C and D to transmit over the A channel.

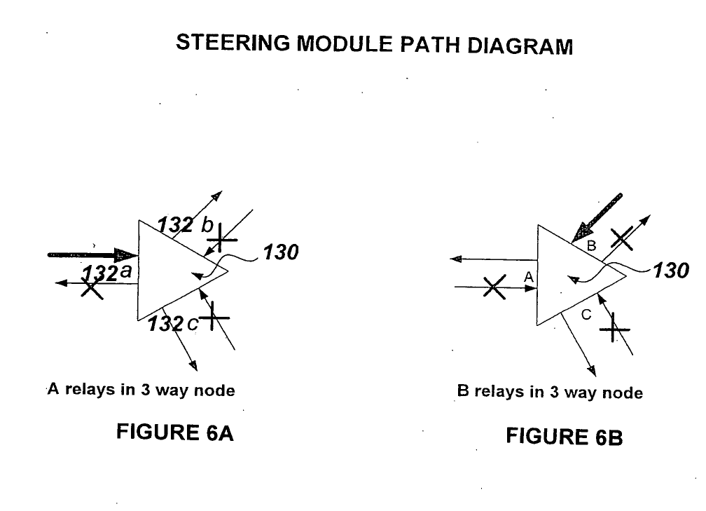

The operation of the steering board, such as the steering board depicted in FIG. 5, is depicted by two FIGS. 6A and 6B that show the operation of the steering boards in the network. Generally, FIGS. 6A and 6B show that data are received on one branch of the node and relayed through to the other branches. During this time, the receivers on the other branches of the node are blocked to prevent them from relaying information back through the transmitting branch. In particular, FIG. 6A shows a node having three branches depicted as 132a, 132b and 132c. Each of the branches 132a through 132c is bi-directional and therefore can both receive and transmit data. In the depicted embodiment, the transmission and reception paths are shown as separate for each branch. However, in other embodiments, various modulation techniques may be employed to allow a single physical transmission medium to carry both the data being transmitted and received by the node 130. FIG. 6A shows that data are being received along branch 132a. This is shown by the darkened arrow coming into node 130. As further shown in FIG. 6A, at the time data are being received at branch 132a, node 130 under the control of the steering board retransmits the incoming signal on channel A on channel 132b and channel 132c. At the same time, the steering board blocks any incoming signals on the input side of channels 132b and 132c to prevent a data collision caused by the simultaneous or near simultaneous input of data into the node on two different or three different channels. FIG. 6B illustrates a similar operation of the steering board, but in this case data are incoming on channel 132b and it is the incoming sides of channels 132a and 132c that are blocked while the outgoing paths of channels 132a and 132c are employed to retransmit the signal incoming on channel 132b.

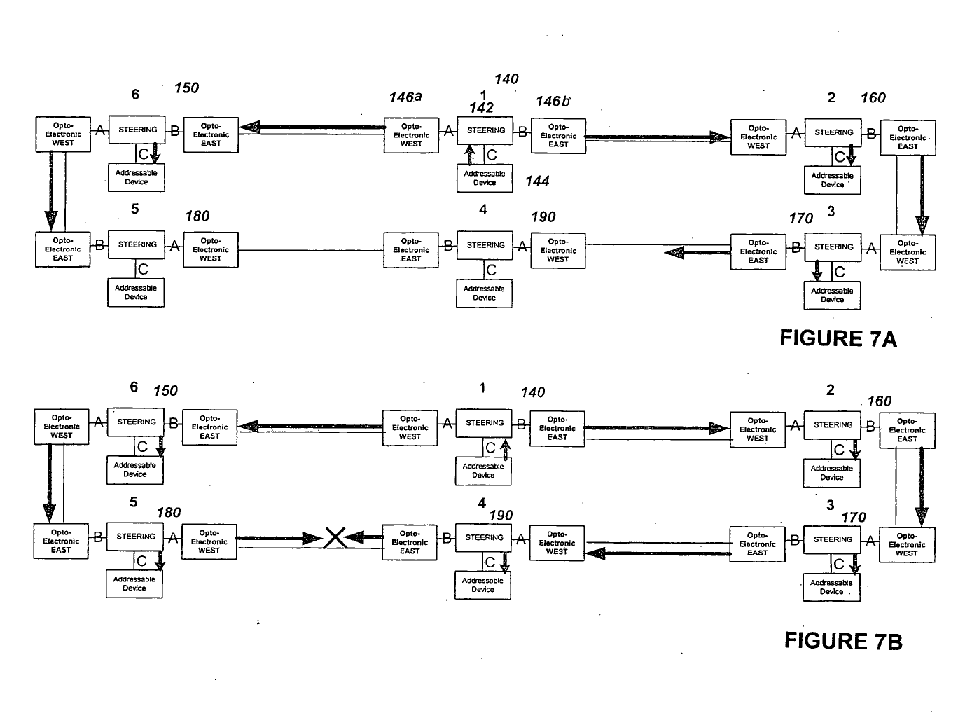

FIGS. 7A and 7B depict two functional block diagrams that show data flow occurring between nodes within a network. FIGS. 7A and 7B depict through the data flow diagrams the operation of the network node to prevent “ring around”. Ring around may occur when a network is configured to broadcast a signal from node to node. If the propagation of the signal continues through the network even after the appropriate node has received and processed the signal, this event is called ring around. Ring around can be problematic as, in certain case, the signal propagates through the network for an indeterminate amount of time. Ring around can result from multiple signals as well as one signal, and the result can be an increase in the amount of data collisions that occur within the network. In the embodiment depicted in FIG. 1, the regional observatory being used with the network covers several thousand kilometers. As such, the repeating of an optical signal from node to node is required. As discussed above, the steering board as shown in FIGS. 6A and 6B acts as a cut through device which electrically regenerates a signal and sends it out to another transceiver or multiple transceivers to broadcast the signal to different nodes in the network. In the embodiment depicted in FIG. 1, the network has a mesh architecture. Consequently, the regenerated propagation of a signal through the mesh is subject to “ring around” or “singing”, a phenomenon wherein the signal which is propagated and repeated from node to node returns to the original sender and is erroneously retransmitted. The design of the steering boards includes a time out feature which stops all node receivers when they are transmitting and for a period of time after that. This allows the cascading signal to quiesce before it is accidentally retransmitted through the mesh network.

Turning to FIG. 7A, the node 140 is shown as comprising three functional block elements, a steering module 142, an addressable module 144 and two optoelectronic boards 146a and 146b. In FIG. 7, the node 140 needs to send data which it received via its C channel through addressable board 144. This might be data that have been solicited from the shore via the master station, or information received via a piece of test equipment coupled to the node. In any case, node 140 checks that its lines are not busy, and then starts a transmission relaying the data from C to lines A and B through cards 146a and 146b respectively. The data begin to travel around the network in both directions (East and West).

FIG. 7B shows the state of the network sometime later. At this point the signal broadcast from node 140 has propagated through nodes 150 and 160 and 170 and 180. Nodes 180 and 170 are now in a race to deliver the signal to node 190. FIG. 7B shows, arbitrarily, that node 190 receives data first from its A channel which couples to node 170. Upon receipt of data from node 170, node 190 raises the “A has the floor” state (Ahtf), causing node 190 to ignore any data being received on its B or C channels, while simultaneously relaying the data it has received on its A channel through its B and C transmission lines. Further shown in FIG. 7B is that a collision of data occurs on that portion of the network between node 180 and 190. In particular, node 190, having received data from node 160, proceeds to transmit the data outward along the C channel and the B channel. The B channel distributes the data to node 180. However, in this case node 180, which was racing with node 170, will, for a period of time set by the timeout circuit, maintain a block on its received line on the A channel. This prevents node 190 from successfully delivering or transmitting the data signal originally broadcast from node 140 to node 180 which would in turn cause the signal to be routed through node 150 back to node 140. Instead, the block on the input channel for node 180 effectively blocks the singing of the transmitted signal, allowing the lines to quiesce with no further passing of data around the network.

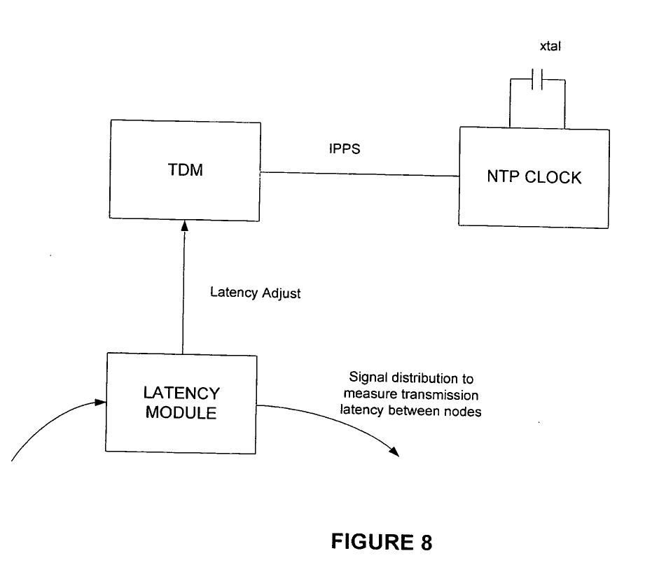

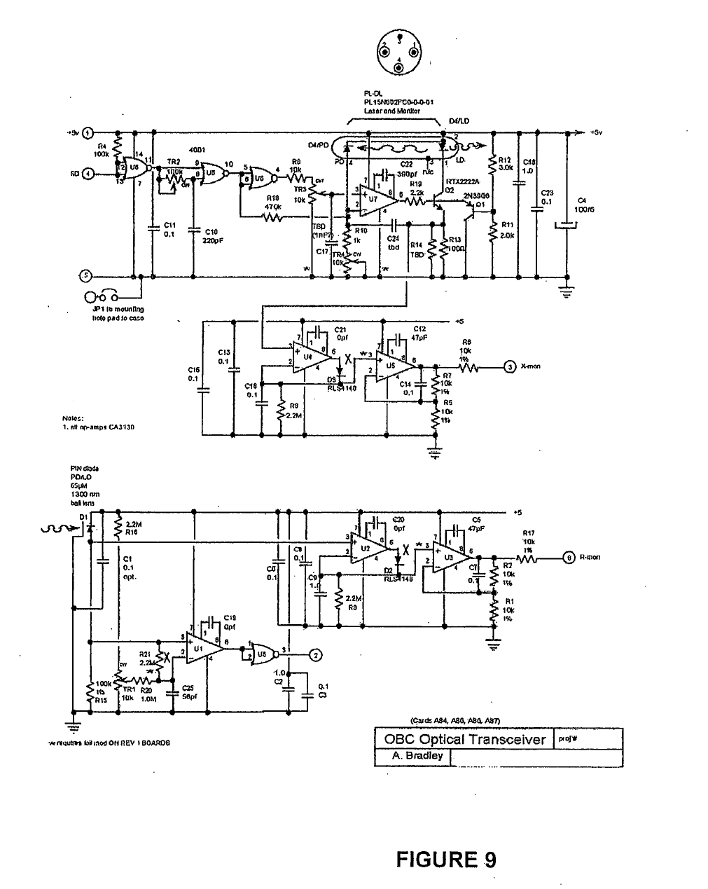

Turning now to FIG. 8, one example of a system for correcting transmission latency among the nodes in the network is depicted. Specifically, there is a time distribution module that is responsible for maintaining a 1 pulse per second signal to science equipment within a jitter tolerance of about 1 microsecond. This time distribution module also updates an NTP clock to a tolerance of about 1 ms. In one embodiment, there is a crystal oscillator located in the module and that crystal oscillator provides the basic clock used by the module. Periodically, updates are received from the shore station to synch the clock with the shore master clock. Logic in the time module accounts for transmission latency when applying updates. In one practice, the transmission latency or propagation delay is accounted for by using a channel to measure the total propagation delay from a shore GPS referenced clock to an individual node. To this end, a time mark is periodically sent so that local clocks at each node can keep time slaved to the GPS reference clock that might be shore side. Each clock is appropriately offset, each with its particular delay value, so that they are truly synoptic. In one embodiment, the system uses CMOS logic to provide only gate and propagation delay variations which may be accounted for as they do not introduce jitter into the clock signal. Other embodiments may be used and realized without departing from the scope of the invention. But in either case, the systems work to maintain a signal that can be propagated as a time signal between the different nodes and that will provide a time signal that adjusts for and accounts for the latency that can arise when transmitting a signal over the many kilometers that separate the different nodes in the observatory network. One embodiment of the clock synchronization update logic is depicted in FIG. 2 that shows the sub sea node 14 as having a clock synchronization logic block 34 that is capable of accounting for any propagation delay or distance delay that arises from the transfer of the clock signal from the shore node 12 to the sub sea node 14.

Turning to FIG. 9, one system for on/off keying of a laser source is depicted. The on/off keying of the laser diode allows for omitting a constant carrier on the laser diode. By removing this constant carrier, the amount of power consumed by the laser diode is substantially reduced. However, by removing the constant carrier, the feedback mechanism normally employed for laser power regulation is removed. To address this, a configuration of an op-amp in the circuit was established. This circuit allows power regulation without a constant carrier. FIG. 9 depicts the power regulator circuit that may be used for the laser diode that is being on/off keyed. In the depicted circuit, feedback control is provided to regulate laser power. This allows for power regulation for the depicted system that does not employ a constant carrier.

Those skilled in the art will know or be able to ascertain using no more than routine experimentation, many equivalents to the embodiments and practices described herein.

Accordingly, it will be understood that the invention is not to be limited to the embodiments disclosed herein, but is to be understood from the following claims, which are to be interpreted as broadly as allowed under the law.

What is claimed is:

1. A communication network capable of installation on the seafloor and comprising
a plurality of network nodes being interconnected by fiber optic cable, and each having
optical transceivers for coupling to an optical fiber cable having data channels carrying data packets among the plurality of network nodes and having one or more control and time channels for carrying control and time signals, and
an out-of-band communications module for coupling to the optical fiber cable to utilize the control and time data signals transmitted separately from the data packets, to provide the distribution of in-band data packets among network nodes and the distribution of out-of-band timing and control signals to said plural network nodes.

2. The communication network according to claim 1, wherein said out-of-band communications module further comprises
a control module for regulating the flow of control and time signals across the optical channel.

3. The communication network according to claim 2, wherein the control module further comprises
a time distribution module for distributing a NIST-traceable time signal corrected for transmission latency among the plural network nodes.

4. The communication network according to claim 3, having
means for measuring the transmission latency among the plural network nodes.

5. A communication network according to claim 2, wherein the control module further includes
an interface controller for selectively allowing a plurality of data channels internal to the network node to access the optical channel carrying control and time signals among the network nodes.

6. A communication network according to claim 5, wherein the control module allows one node at a time to access the control and time signals among all of the network nodes.

7. A communication network according to claim 5, wherein the module further includes
a media access controller for blocking data from being received over a channel in response to detecting data being received on another channel.

8. A communication network according to claim 2, further comprising
a control circuit for regulating access to a given optical path carrying control and time signals among the network nodes and capable of suppressing multiple repeats of said signal.

9. An out-of-band communication network according to claim 1, further comprising
a serial interface circuit for communicating optical data over the optical channel at a rate of between 50 BAUD (Bits Per Second) and 115,000 BAUD.

10. A communication network according to claim 9, further comprising
a base band keying circuit for on/off keying a laser diode to generate data signals for distribution over the optical channel.

11. A communication network according to claim 10, wherein the laser diode comprises a communications laser.

12. An out-of-band communication network according to claim 10, further comprising
a power regulator circuit for regulating the power applied to the laser diode.

13. A communication network according to claim 12, wherein
the power regulator circuit utilizes the internal Laser Diode monitor diode to monitor optical power generated by the laser diode using a non-carrier based communications protocol and a feedback loop to regulate the power generated thereby.

14. A communication network according to claim 1, further comprising
a low power sleep mode allowing a control module to turn itself off by timed prearrangement or by lack of incoming signals.

15. A communication network according to claim 1, having in situ battery power for at least one week.

16. A communication network according to claim 13, further comprising a wake-up circuit for causing the device to enter into an active state in response to an incoming signal.

17. A communication network according to claim 16, further comprising a time distribution system for synchronizing clocks within the network nodes in response to a timing pulse transmitted over the optical channel.

18. A communication network according to claim 1, wherein the network nodes are arranged in an architecture selected from the group consisting of a mesh architecture, a bus architecture, a ring architecture, or a star architecture.

19. A communication network, comprising
a master node having
a data packet generator,
control and time distribution circuits for generating control and time signals, and
a NIST-traceable time source,
a steering module to allow operation in mesh, bus, ring, or star architectures,
an optical transceiver for transmitting and receiving data as optical signals over an optic channel, and
a plurality of network nodes arranged into a selected network configuration, and further having
an optical transceiver for coupling to an optical channel carrying data packets among the plurality of network nodes and having a control and time channel for carrying control and time signals, and
an out-of-band communications module for coupling to the optical fiber cable to detect the control and time signals transmitted separately from the data packets, to thereby provide the distribution of in-band data packets among network nodes and the distribution of out-of-band time and control signals to said plural network nodes.
